(19) United States
(12) Patent Application Publication
(10) Pub. No.: US 2022/0057975 A1
(43) Pub. Date: Feb. 24, 2022

(54) PRINTED MATTER MANAGEMENT DEVICE, PRINTED MATTER MANAGEMENT SYSTEM, AND PROGRAM

(71) Applicant: Konica Minolta, Inc., Tokyo (JP)

(72) Inventor: SHOKO HABA, Toyokawa-shi (JP)

(21) Appl. No.: 17/371,843

(22) Filed: Jul. 9, 2021

(30) Foreign Application Priority Data
Aug. 21, 2020 (JP) 2020-139854

(51) Int. Cl. G06F 3/12; G06K 19/06

(52) U.S. Cl. CPC G06F 3/1256; G06K 19/06037; G06F 3/1238

(57) ABSTRACT

A printed matter management device includes: a hardware processor that: requests storage confirmation information for confirming whether a printed matter to be managed is stored from a user who has printed the printed matter; determines whether the printed matter is stored based on the storage confirmation information; and records a determination result.

The entire disclosure of Japanese patent Application No. 2020-139854, filed on Aug. 21, 2020, is incorporated herein by reference in its entirety.

### BACKGROUND

### Technological Field

The present disclosure relates to a printed matter management device that manages a printed matter such as a printed document.

### Description of the Related art

With an increase in work outside the office such as telework, printed matters such as documents printed in the office are increasingly taken out of the office. At that time, in a case where the printed matter is lost and the lost printed matter is transferred to a malicious third party, information leakage occurs. In this manner, a risk of information leakage is increasing due to the increase in taking out of the printed matters, and countermeasures against the information leakage are required.

JP 2008-176480 A discloses a system that manages taking out of a target to be managed including the printed matter using an electronic tag and transmits a notification mail to a user who takes out the target to be managed when a returning deadline passes. According to this system, when and by whom the target to be managed is taken out is managed by the electronic tag, so that it is possible to track a leakage route when information leakage is found.

In the disclosure of JP 2008-176480 A, a timing at which the loss of the target to be managed is found is when the target to be managed is not returned even after a returning deadline. Rapid support is important as countermeasures against information leakage, and for this purpose, it is required to grasp occurrence of the loss of the object to be managed that causes occurrence of the information leakage at an earlier timing.

In a case where a person who takes out the target to be managed loses the target to be managed, there is a possibility of a problem that the loss is camouflaged and a timing at which an administrator grasps the loss of the target to be managed is delayed.

### SUMMARY

In view of the above-described problems, an object of the present disclosure is to provide a printed matter management device, a printed matter management system, and a program that make it difficult to camouflage the loss of the printed matter and may grasp the occurrence of the loss of the printed matter at an earlier timing than before.

To achieve the abovementioned object, according to an aspect of the present invention, a printed matter management device reflecting one aspect of the present invention comprises: a hardware processor that: requests storage confirmation information for confirming whether a printed matter to be managed is stored from a user who has printed the printed matter; determines whether the printed matter is stored based on the storage confirmation information; and records a determination result.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a system configuration diagram illustrating a configuration of an image forming system;

FIG. 2 is a block diagram illustrating a configuration of a control device;

FIG. 3A is a view illustrating an example of a data configuration of user information;

FIG. 3B is a view illustrating an example of a data configuration of administrator information;

FIG. 4 is a view illustrating an example of a data configuration of print information;

FIGS. 5A to 5C are views illustrating an example of a data configuration of printed matter-related information;

FIGS. 6A to 6C are views illustrating an example of a data configuration of management setting information;

FIGS. 7A and 7B are views illustrating an example of a data configuration of additional print setting information;

FIG. 8 is a view illustrating an example of a data configuration of a confirmation result DB;

FIG. 9 is an example of a flowchart illustrating an operation of a printed matter management device;

FIG. 10 is an example of a flowchart illustrating an operation of a user terminal;

FIGS. 11A and 11B are examples of icon display notifying a user of newly-arrived information;

FIGS. 12A and 12B are views for explaining a method of generating storage confirmation information;

FIG. 13 is a view for explaining a method of generating storage confirmation information;

FIGS. 14A and 14B are views for explaining a method of generating storage confirmation information;

FIGS. 15A to 15C are views for explaining a method of generating storage confirmation information;

FIGS. 16A to 16C are views for explaining a password additionally printed on a printed matter; and

FIG. 17 is a system configuration diagram illustrating a configuration of an image forming system.

### DETAILED DESCRIPTION OF EMBODIMENTS

Hereinafter, a printed matter management system 1 as one or more embodiments of the present invention will be described with reference to the drawings. However, the scope of the invention is not limited to the disclosed embodiments.

1Embodiment

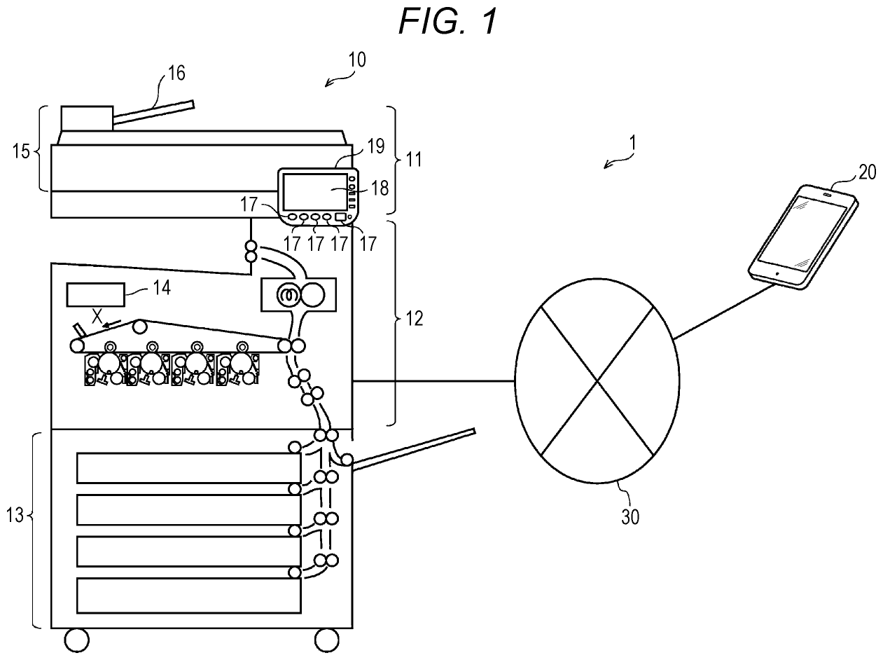

As illustrated in FIG. 1, the printed matter management system 1 includes a printed matter management device 10 and a user terminal 20. The printed matter management device 10 and the user terminal 20 are connected to each other via a network 30.

1.1 Printed Matter Management Device 10

The printed matter management device 10 according to a first embodiment is a multifunction peripheral (MFP) having scanner, printer, and copier functions.

As illustrated in FIG. 1, the printed matter management device 10 is provided with a paper feeder 13 that accommodates and feeds sheets in a lower portion of a housing. Above the paper feeder 13, a printer 12 that forms an image by an electrophotographic method is provided. A scanner 11 that reads an original surface to generate image data and an operation panel 19 that displays an operation screen and receives an input operation from a user are provided above the printer 12.

The scanner 11 is provided with an automatic original conveyance device 15. The automatic original conveyance device 15 conveys originals set on an original tray 16 one by one to an original glass platen. The scanner 11 scans (reads) an image of the original conveyed to a predetermined position on the original glass platen by the automatic original conveyance device 15 by a scanner, and obtains image data including multi-value digital signals of red (R), green (G), and blue (B). The scanner 11 writes the obtained image data in a HDD 110 (described later).

The image data of respective color components obtained by the scanner 11 undergoes various types of data processing in a control device 14, and is further converted into image data of respective reproduction colors of yellow (Y), magenta (M), cyan (C), and black (K).

The printer 12 includes an intermediate transfer belt, a driving roller on which the intermediate transfer belt is stretched, a driven roller, a backup roller, a plurality of image forming units arranged at predetermined intervals in a travel direction X of the intermediate transfer belt so as to face the intermediate transfer belt, a fixing unit and the like.

Each image forming unit includes a photosensitive drum being an image carrier, an LED array for exposing and scanning a surface of the photosensitive drum, a charging charger, a developer, a cleaner, a primary transfer roller and the like.

The paper feeder 13 is formed of a plurality of paper feed cassettes that accommodates sheets of different sizes and pickup rollers for delivering the sheets from the paper feed cassettes to a conveyance path, and a manual feed tray on which the sheets are to be placed and a pickup roller for delivering the sheets from the manual feed tray to the conveyance path.

In each of the image forming units, each photosensitive drum is uniformly charged by the charging charger and exposed by the LED array, and an electrostatic latent image is formed on the surface of the photosensitive drum. The electrostatic latent images are developed by the developers of the respective colors, toner images of Y to K colors are formed on the surface of the respective photosensitive drums, and the toner images are sequentially transferred onto a surface of the intermediate transfer belt by an electrostatic action of each primary transfer roller arranged on a back surface side of the intermediate transfer belt. As a result, a color toner image is formed on the surface of the intermediate transfer belt.

In contrast, the sheet is fed from any paper feed cassette or the manual feed tray of the paper feeder 13 in accordance with an image forming operation by each image forming unit, conveyed on the conveyance path to a secondary transfer position in which a secondary transfer roller and a backup roller face each other with the intermediate transfer belt interposed therebetween, and the color toner image on the intermediate transfer belt is secondarily transferred to the sheet in the secondary transfer position by an electrostatic action of the secondary transfer roller. The sheet on which the toner images of Y to K colors are secondarily transferred is further conveyed to the fixing unit.

The toner image on a surface of the sheet is fused and fixed to the surface of the sheet by heating and pressurization when passing through a fixing nip formed between a heating roller and a pressure roller pressed against the same of the fixing unit and the sheet passes through the fixing unit and then is sent to a discharge tray.

The operation panel 19 is provided with a display unit 18 including a liquid crystal display plate and the like, and displays a content set by the user and various messages. For example, in a case where loss by the user of a printed matter managed by the printed matter management device 10 is found, the display unit 18 may display a message and the like notifying an administrator of this.

The operation panel 19 is provided with an input unit 17, and receives a print instruction and the like from the user. Note that the input unit 17 may include a touch sensor provided on a surface of the display unit 18, numeric keys for inputting numerical values not illustrated and the like. The operation panel 19 notifies the control device 14 of the received content.

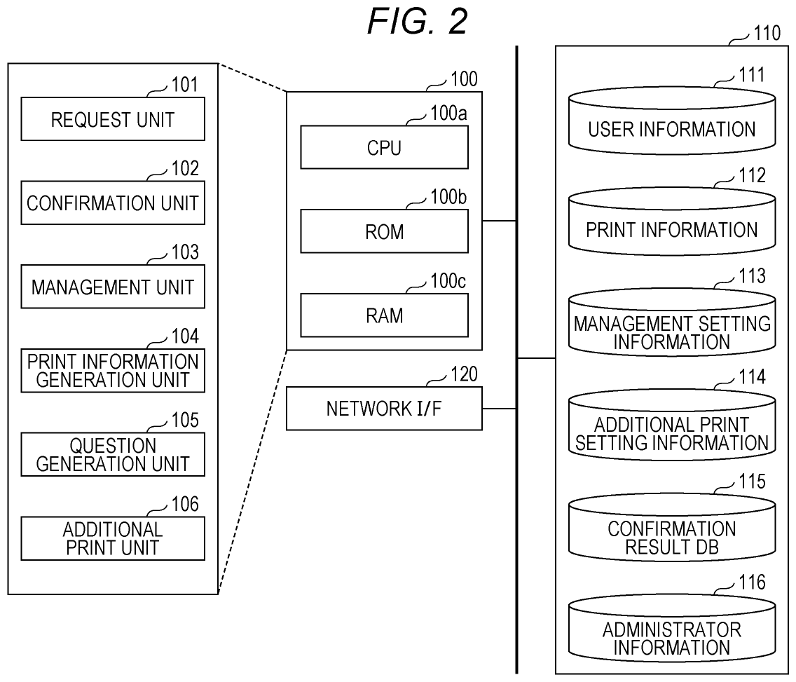

FIG. 2 is a block diagram illustrating a configuration of the control device 14. As illustrated in FIG. 2, the control device 14 is provided with a main controller 100, a hard disk drive (HDD) 110, and a network interface (IF) 120.

(1) Main Controller 100

The main controller 100 is formed of a central processing unit (CPU) 100a , a read only memory (ROM) 100b , a random access memory (RAM) 100c and the like. The RAM 100c is formed of a semiconductor memory, temporarily stores various control variables and the like, and provides a work area when the CPU 100a executes a program. The ROM 100b is formed of a semiconductor memory, and stores in advance a control program and the like for executing various jobs such as a scan job, a copy job, or a print job.

The CPU 100a is formed of a fetch unit, a decryption unit, an execution unit, a register file, an instruction counter and the like. The fetch unit reads each instruction code included in the control program one by one from the control program stored in the ROM 100b . The decryption unit decrypts the read instruction code. The execution unit operates according to a decryption result. In this manner, the CPU 100a operates according to the control program stored in the ROM 100b.

The main controller 100 integrally controls the HDD 110, the network IF 120, the scanner 11, the printer 12, the paper feeder 13, and the operation panel 19 for executing the scan job, the copy job, the print job or the like according to the control program.

The main controller 100 serves as a request unit 101, a confirmation unit 102, a management unit 103, a print information generation unit 104, a question generation unit 105, and an additional print unit 106 according to the control program.

(1-1) Request Unit 101

The request unit 101 refers to management setting information 113 and print information 112 stored in the HDD 110, specifies a printed matter to be managed, and transmits a message requesting storage confirmation information for confirming whether the printed matter is stored to a user who stores the specified printed matter. Note that transmission and reception of a message from A to B in the present disclosure includes A storing the message in a specific location and B accessing the specific location to obtain the message.

(1-2) Confirmation Unit 102

The confirmation unit 102 refers to the storage confirmation information received from the user and the print information stored in the HDD 110 to confirm whether the user appropriately stores the printed matter.

(1-3) Management Unit 103

The management unit 103 generates a confirmation result DB 115 using a confirmation result by the confirmation unit 102 and stores the same in the HDD 110, or updates the confirmation result DB 115 stored in the HDD 110. In a case where the loss of the printed matter by the user is found as a result of the confirmation by the confirmation unit 102, the management unit 103 refers to the management setting information 113 stored in the HDD 110 and performs processing based on a setting content thereof.

(1-4) Print Information Generation Unit 104

When the printed matter management device 10 executes image formation processing to generate the printed matter, the print information generation unit 104 generates the print information 112 based on user login information, print job information, user input information and the like at that time, and stores the same in the HDD 110.

(1-5) Question Generation Unit 105

The question generation unit 105 generates a question regarding an object printed on the printed matter and an answer thereto. Herein, the object is data showing either a text or an image (graph, table, drawing, photograph). As for the text object, in a case where the print job information includes text information, the information may be used, or it is also possible to obtain the text information by performing OCR processing on the image data. The question and the answer may be generated, for example, by extracting an answer from the object printed on the printed matter in response to a predetermined question such as “What are the first five characters of P1?”. Specifically, if a first sentence of a document P1 is “I always called the person the teacher.”, it is possible to extract the first five characters and generate “I alwa” as an answer. That is, the question is “What are the first five characters of P1?” and the answer is “I alwa”.

As for the object such as the graph, table, drawing, and photograph, the question and answer may be generated based on information such as the number, position, color, and title of each object. For example, if there are three images in P3 of the printed matter, it is possible to generate “How many images are printed in P3?” as a question and generate “3” as an answer In a case where one drawing is printed in P2 of the printed matter and a title thereof is printed in red, it is possible to generate “What is the color of the title of the drawing in P2?” as a question and generate “red” as an answer. In a case where there are two graphs in P4 of the printed matter, the first graph printed on an upper side of P4, the second graph printed on a lower side of P4, and a title of the second graph is “aggregation result”, it is possible to generate “What is the title of the graph on a lower side of P4?” as a question and generate “aggregation result” as an answer.

A method of generating a question and answer pair is not limited to the above, and other known methods may also be used.

(1-6) Additional Print Unit 106

When the printed matter management device 10 executes the image formation processing to generate the printed matter, the additional print unit 106 refers to the management setting information 113 and the additional print setting information 114 stored in the HDD 110, and performs additional printing on the printed matter according to the setting content.

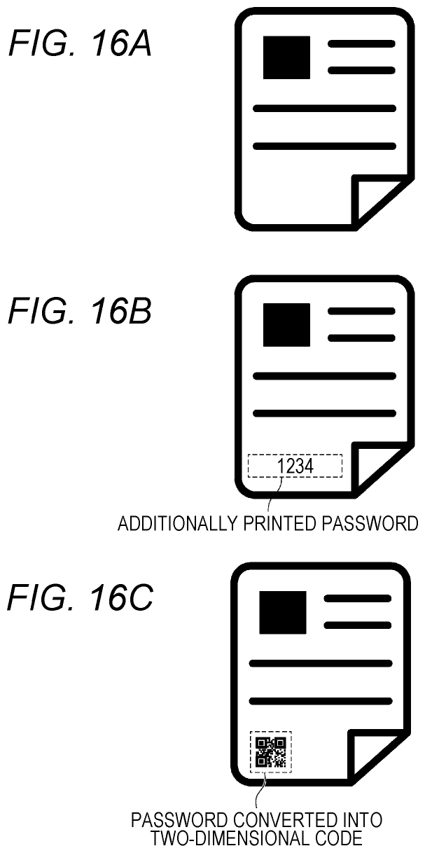

For example, in a case where the setting content is to additionally print a predetermined object on the printed matter, the additional print unit 106 controls the printer 12 to generate a print image obtained by combining a predetermined object with the print image based on the print job information, and to print the print image with which the predetermined object is combined. FIG. 16A is an example of the print image based on the print job information, FIG. 16B is an example of the print image with which a password is combined in a text format as a predetermined object, and FIG. 16C is an example of the print image with which the password converted into a two-dimensional code is combined as a predetermined object.

(2) HDD110

As illustrated in FIG. 2, the HDD 110 is provided with an area for storing and recording the user information 111, the print information 112, the management setting information 113, the additional print setting information 114, the confirmation result database (DB) 115, and administrator information 116.

(2-1) User Information 111 and Administrator Information 116

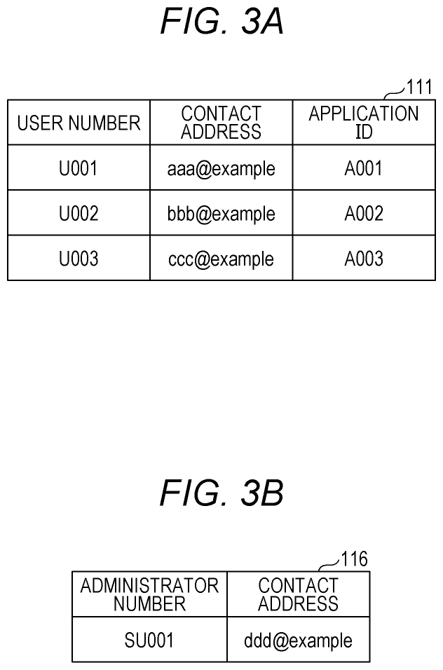

FIG. 3A is a view illustrating an example of a data configuration of the user information 111 stored in the HDD 110. The user information includes a user number, a contact address, and an application ID for each user. The user number is an identifier for uniquely specifying the user registered in the printed matter management device 10. The contact address is information indicating a contact address of the user such as a mail address of the user. The application ID is an identifier for specifying the user in a dedicated application installed in a user terminal possessed by the user, and is used in a case where communication with the user is performed using the dedicated application.

FIG. 3B is a view illustrating an example of a data configuration of the administrator information 116 stored in the HDD 110. An administrator number and a contact address are included for each administrator. The administrator number is an identifier for uniquely specifying the administrator registered in the printed matter management device 10. The contact address is information indicating a contact address of the administrator such as a mail address of the administrator.

(2-2) Print Information 112

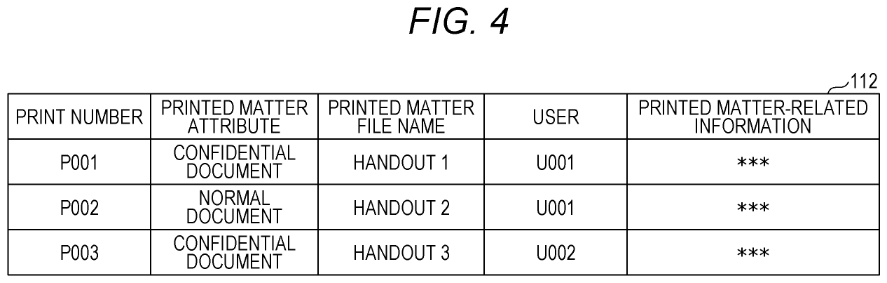

FIG. 4 is a view illustrating an example of a data configuration of the print information 112 stored in the HDD 110. The print information 112 includes a print number, a printed matter attribute, a printed matter file name, a user, and printed matter-related information.

The “print number” is an identifier assigned each time the printing is performed by the printed matter management device 10 for uniquely specifying each printing.

The “printed matter attribute” is information indicating an attribute assigned at the time of printing. For example, attribute information such as whether a document is a confidential document or a normal document is recorded. The printed matter attribute may be recorded as the confidential document in a case where the print job information includes metadata indicating that the document is the confidential document, or in a case where printed text data includes a character string such as “confidential”.

The “printed matter file name” is a file name of a print target included in the print job information.

The “user” is a user number indicating the user who performs the printing.

The “printed matter-related information” is information used for determining whether the user appropriately stores the printed matter by collating the same with the storage confirmation information received from the user. There is a plurality of types of methods of determining whether the user appropriately stores the printed matter, and the printed matter-related information differs depending on the determination method.

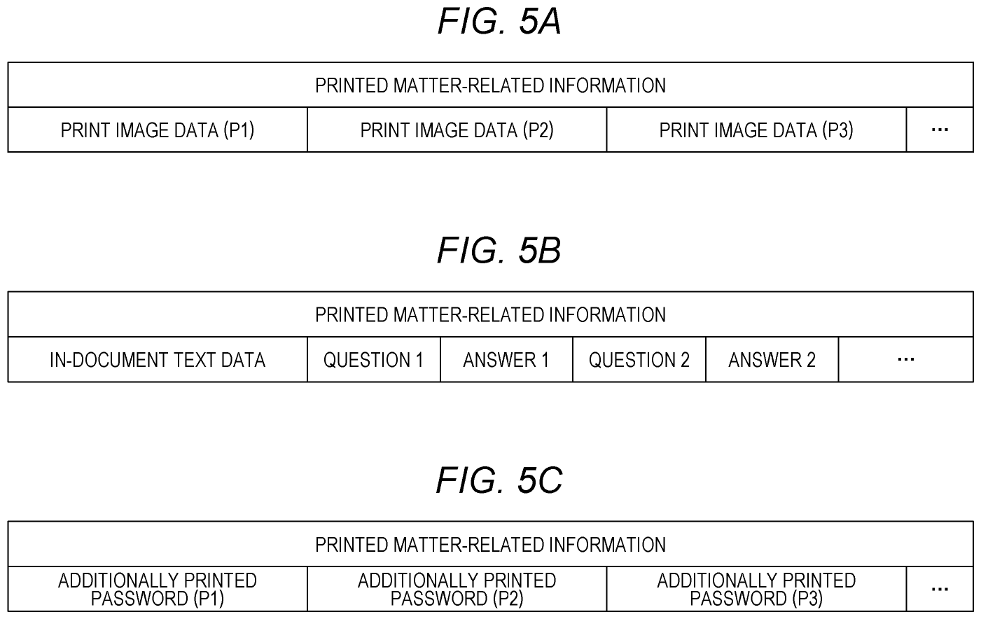

The method of determining whether the user appropriately stores the printed matter may be the method of allowing the user to image the stored printed matter with a camera, receiving captured image data as the storage confirmation information, and collating the received storage confirmation information with the printed matter-related information. In this case, the printed matter-related information is print image data obtained by imaging a print content. In a case where the printed matter includes a plurality of pages, the print image data of each page is recorded as the printed matter-related information. FIG. 5A illustrates an example of a data configuration of the printed matter-related information in a case where the print image data is stored as the printed matter-related information. Note that the printed matter-related information is not limited to the print image data itself as long as this may generate the print image data, and may be, for example, document data described in a language such as PDL and print setting information such as color printing and gray printing.

The method of determining whether the user appropriately stores the printed matter may be a method of obtaining the answer to the question regarding the object printed on the printed matter from the user. In this case, the printed matter-related information is object data of a print content and the question and answer generated from the object data in the question generation unit 105. A plurality of pairs of questions and answers may be recorded, and a different question may be asked each time the user is confirmed. FIG. 5B illustrates an example of a data configuration of the printed matter-related information in a case where the object data of the print content and the question and answer generated from the object data are stored as the printed matter-related information.

The method of determining whether the user appropriately stores the printed matter may be the method of obtaining the password additionally printed on the printed matter from the user. In this case, the printed matter-related information is the password additionally printed on the printed matter. FIG. 5C illustrates an example of a data configuration of the printed matter-related information in a case where the password additionally printed on the printed matter is stored as the printed matter-related information. The password additionally printed on the printed matter may be different between the pages of the printed matter. In a case where the password is converted into the two-dimensional code and additionally printed, the user may obtain the password by using a two-dimensional code reader provided on the user terminal 20.

(2-3) Management Setting Information 113

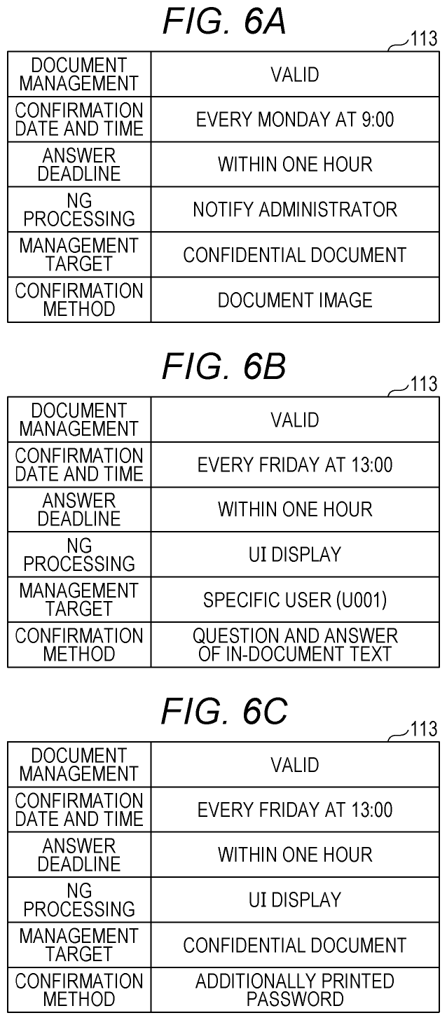

FIGS. 6A to 6C are views illustrating examples of a data configuration of the management setting information 113 and a data content thereof set in advance by the administrator of the printed matter management device 10 and stored in the HDD 110.

An item of “document management” is a set value indicating whether the printed matter management device 10 executes confirmation processing of whether the user appropriately stores the printed matter. It is indicated that, in a case where this is set to “valid”, the printed matter management device 10 executes the confirmation processing, and in a case where this is set to “invalid”, the printed matter management device 10 does not execute the confirmation processing.

An item of “confirmation date and time” is a set value indicating when the confirmation processing is performed. As illustrated in FIG. 6A, in a case where this is set to “every Monday at nine”, it is indicated that the confirmation processing is executed every Monday at nine a.m.

An item of “answer deadline” is a set value indicating a period from the date and time indicated by “confirmation date and time”. It is indicated that, in a case where it is not possible to confirm that the user appropriately stores the printed matter by this deadline, it is assumed that the user has lost the printed matter and the fact is recorded, and following NG processing is executed.

An item of “NG processing” indicates processing performed in a case where it is determined that the user has lost the printed matter. For example, in a case where the item “NG processing” is set to “notify administrator”, the contact address of the administrator is obtained with reference to the administrator information 116 stored in the HDD 110, and a message notifying that the user has lost the printed matter is transmitted to the obtained contact address. For example, in a case where the item of “NG processing” is set to “UI display”, notification that the printed matter has been lost is displayed on a display of the operation panel 19. For example, in a case where the item of “NG processing” is set to “prohibit use of document”, processing of prohibiting the printing using the print data of the lost printed matter and disabling the printing is performed. The NG processing is not limited to the above, and other processing may be performed.

An item of “management target” is a set value that defines a target on which confirmation processing of whether the user appropriately stores the printed matter is performed. For example, in a case where the item of “management target” is set to “confidential document”, the printed matter “printed matter attribute” of which is “confidential document” in the print information 112 becomes a target. For example, in a case where the item of “management target” is set to “specific user (U001)”, the printed matter of which “user” is “U001” in the print information 112 becomes a target. Note that, if information such as a group to which the user belongs is recorded as user information in the user information 111, it is also possible to target all the users belonging to the group by specifying the information.

An item of “confirmation method” is a set value indicating which of the above-described determination methods is used as the confirmation processing of whether the user appropriately stores the printed matter.

(2-4) Additional Print Setting Information 114

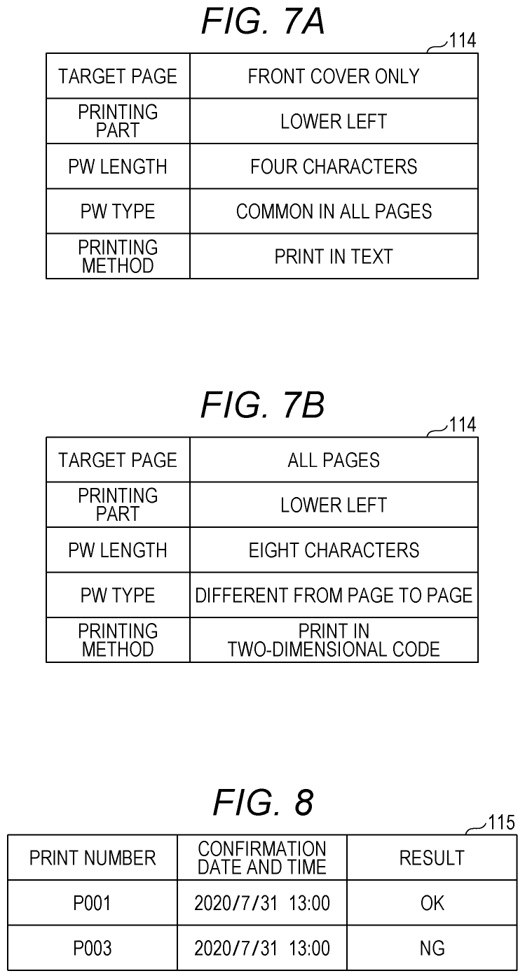

FIGS. 7A and 7B are views illustrating examples of a data configuration of the additional print setting information 114 and a data content thereof set in advance by the administrator of the printed matter management device 10 and stored in the HDD 110.

Note that the additional print setting information 114 is setting information that is valid in a case where the item of “document management” of the management setting information 113 is “valid” and the item of “confirmation method” is “additionally printed password”.

An item of “target page” is a set value that defines on which page the password is additionally printed. An item of “printing portion” is a set value that defines in which position in the page the password is additionally printed. An item of “PW length” is a set value that defines a length of the password. “PW type” is a set value that defines whether different passwords are additionally printed on the respective pages or a common password is additionally printed on all the pages. “Printing method” is setting that defines whether the password is additionally printed in a text format or is converted into a two-dimensional code and additionally printed.

(2-5) Confirmation Result DB 115

FIG. 8 is a view illustrating an example of a data configuration of the confirmation result DB 115 stored in the HDD 110.

This is a database indicating a confirmation result in a case where the printed matter management device 10 executes the confirmation processing of whether the user appropriately stores the printed matter, and each record includes “print number”, “confirmation date and time”, and “confirmation result”. In an item of “print number”, a print number is recorded for specifying for which printing out of print records recorded in the print information 112 the confirmation result is. In an item of “confirmation date and time”, the date and time when the confirmation processing is performed is recorded. In an item of “confirmation result”, the confirmation result is recorded.

(3) Network IF 120

The network IF 120 transmits a message and the like requesting the storage confirmation information to the user terminal 20 through the network 30.

The network IF 120 receives an execution instruction and an execution condition of the print job (print job information) in the printed matter management device 10 from an external terminal device including the user terminal 20 via the network 30, and controls the printer 12 with the received print job information to execute the printing.

1.2 User Terminal 20

The user terminal 20 may be a smartphone, a notebook PC, or a desktop PC. Herein, it is described assuming that the user terminal 20 is a smartphone.

The user terminal 20 is provided with a camera and a storage area for storing image data generated by imaging with the camera. The user terminal 20 has a two-dimensional code reader function of reading a two-dimensional code such as a QR code (registered trademark), and has a function of decoding the two-dimensional code in a case where the two-dimensional code is included in an imaging range of the camera. The user terminal 20 is provided with an inputter such as a touch panel and a display part such as a display, and appropriately obtains information input according to a user interface (UI).

A dedicated application for managing the printed matter is installed in the user terminal 20. The user terminal 20 receives the message from the printed matter management device 10 through the dedicated application. The user terminal 20 also transmits the image data stored in the above-described storage area, information input by the user using the inputter and the like to the printed matter management device 10 through the dedicated application. In a case of receiving the message from the printed matter management device 10, the dedicated application may notify the user of reception of the message from the printed matter management device 10 using a function such as push notification. The dedicated application is assigned with a different application ID for each user, and the application ID is used to identify the user.

1.3 Network 30

The network 30 includes a wireless network such as LAN and Wifi (registered trademark). The Internet and a wireless network for mobile terminal may also be included.

1.4 Operation

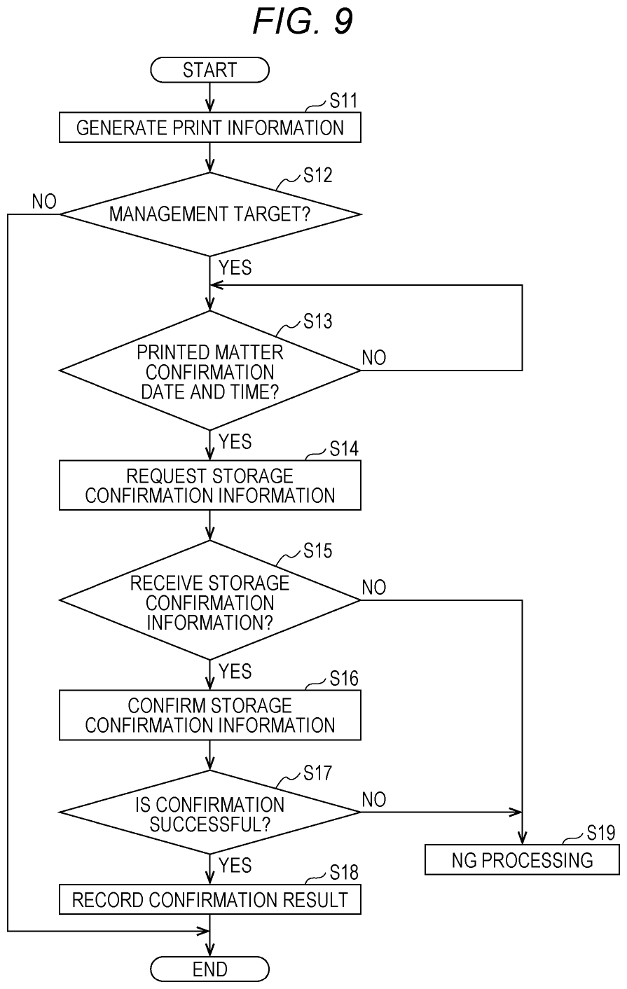

FIG. 9 is a flowchart illustrating an example of an operation of the printed matter management device 10.

When the user performs the printing using the printed matter management device 10, the print information generation unit 104 generates the print information 112 using the user login information, the print job information and the like, and stores the same in the HDD 110 (step S11). Note that, in a case where a print user cannot be specified such as when the user does not log in, it is possible to interrupt the printing, provide display prompting login or display prompting an input of the user information on the operation panel 19, and obtain the user information from the user.

The request unit 101 determines whether the printed document is a document to be managed based on the print information 112 and the management setting information 113 stored in the HDD 110 (step S12). For example, in a case where the item of “document management” in the management setting information 113 is “valid” and the item of “management target” is “confidential document”, the printed matter in which the item of “printed matter attribute” is “confidential document” in the print information 112 is the document to be managed. In a case where the printed document is not the management target (step S12: No), the procedure ends.

In a case where the printed document is the document to be managed (step S12: Yes), the request unit 101 refers to the management setting information 113 and determines whether the current date and time is the confirmation date and time (step S13). In a case where the current date and time is not the confirmation date and time (step S13: No), this stands by until the confirmation date and time.

In a case where the current date and time is the confirmation date and time (step S13: Yes), the request unit 101 transmits a message requesting the document storage information to the user terminal 20 (step S14). In the present disclosure, storing the message in a predetermined server in association with the application ID included in the user information 111 is also regarded as transmission of the message.

After transmitting the message, it is determined whether the document storage information is received from the user terminal 20 by the answer deadline (step S15).

In a case where the document storage information is received from the user terminal 20 by the answer deadline (step S15: Yes), the confirmation unit 102 confirms whether the user stores the printed matter without losing the same by using the received document storage information and the printed matter-related information in the print information 112 stored in the HDD 110 (step S16).

In a case where it is confirmed that the user stores the printed matter without losing the same (step S17: Yes), the management unit 103 records that the user stores the printed matter without losing the same in the confirmation result DB 115 (step S18).

In a case where the document storage information is not received from the user terminal 20 by the answer deadline (step S15: No), or in a case where confirmation of whether the user stores the printed matter without losing the same is not succeeded, the management unit 103 regards that the user has lost the printed matter, and executes the processing set in the item of “NG processing” with reference to the management setting information 113 (step S19), and records that the user has lost the printed matter in the confirmation result DB 115 (step S18).

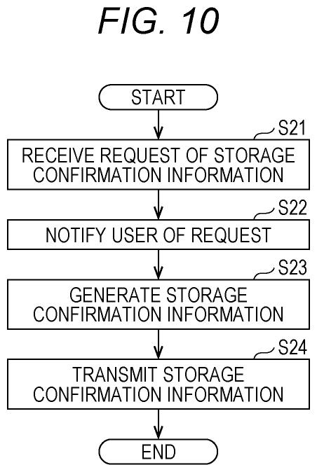

FIG. 10 is an example of an operation of the user terminal 20.

First, the user terminal 20 receives the message requesting the document storage information transmitted from the printed matter management device 10 (step S21). In the present disclosure, accessing a predetermined server to obtain a message associated with its own application ID is also regarded as reception of the message.

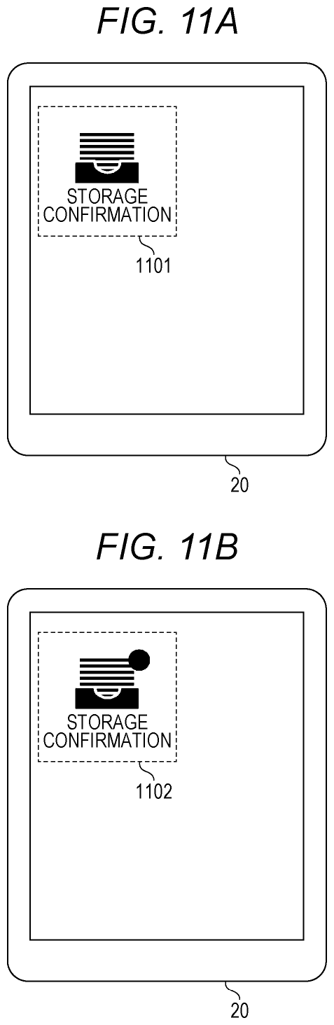

The user terminal 20 that receives the message notifies the user that the message is received (step S22). For example, the user terminal 20 assigns an icon badge indicating that there is newly-arrived information to an icon of the dedicated application displayed on a standby screen, thereby notifying the user of the message from the printed matter management device 10. FIG. 11A is an example illustrating an icon 1101 of the dedicated application in a case where there is no message, and FIG. 11B is an example illustrating an icon 1102 of the dedicated application to which the icon badge is assigned in a case where there is the message.

When the user operates the user terminal 20 to execute the dedicated application, a screen prompting generation of the storage confirmation information is displayed on the user terminal 20 according to the received message. The storage confirmation information is generated when the user operates the user terminal 20 according to the display (step S23), and the generated printed matter management information is transmitted to the printed matter management device 10 (step S24).

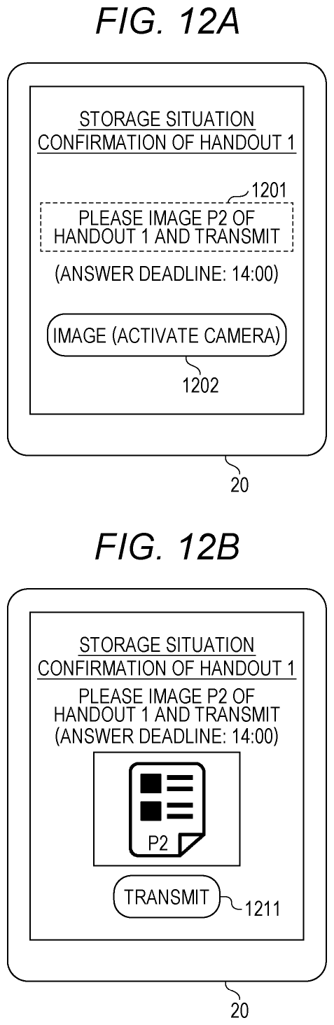

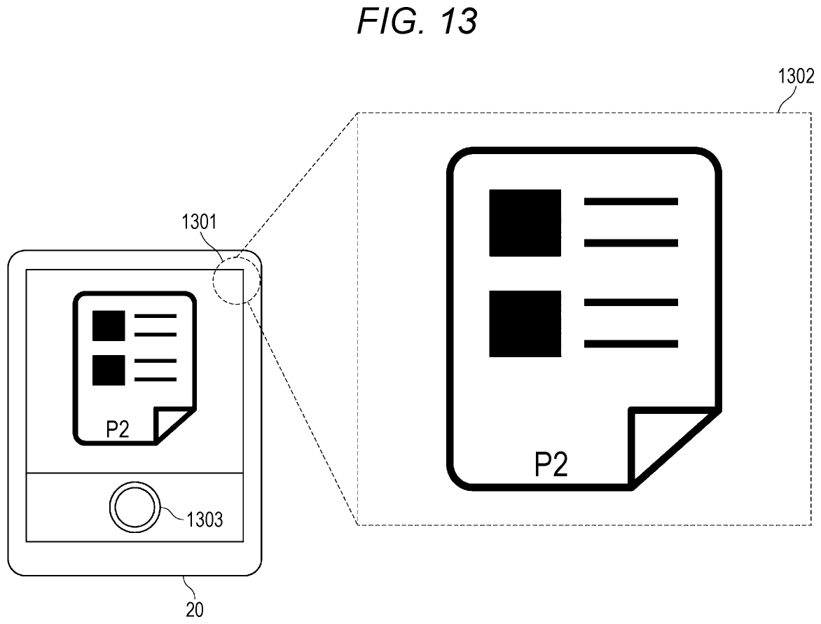

The generation of the storage confirmation information in a case where the captured image data is made the storage confirmation information is described. FIG. 12A is an example of the screen prompting the generation of the storage confirmation information displayed on the user terminal 20. On the screen, a message 1201 indicating an imaging part in the printed matter and a button icon 1202 for activating the camera are displayed. By activating the camera by tapping the button icon 1202, turning a lens 1301 of the camera arranged on a back surface of the user terminal 20 to the printed matter as illustrated in FIG. 13, and tapping the imaging button 1303 of the user terminal 20 so that the imaging part of the printed matter (second page of the printed matter) falls within an imaging range 1302, a captured image data of the imaging part of the printed matter (second page of the printed matter) is generated as the storage confirmation information. After imaging, the screen is switched to a transmission confirmation screen of the storage confirmation information an example of which is illustrated in FIG. 12B, and when a button icon 1211 for transmitting the storage confirmation information to the printed matter management device 10 is tapped, the generated storage confirmation information is transmitted to the printed matter management device 10. Note that the printed matter management device 10 may request imaging of different imaging parts as the storage confirmation information each time the confirmation processing is performed.

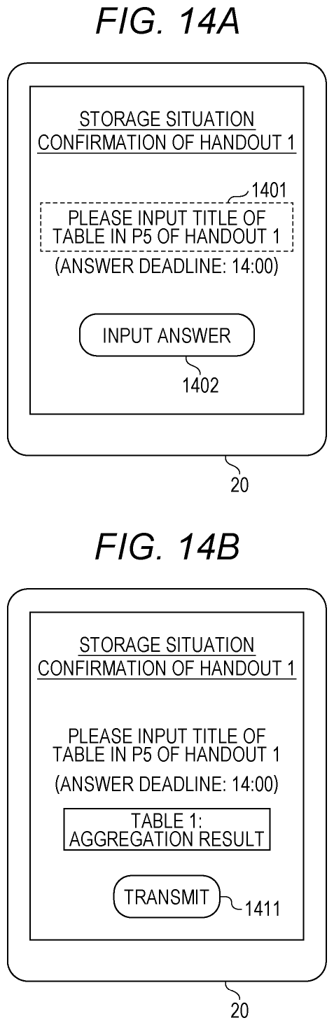

The generation of the storage confirmation information in a case where a question regarding an object (text) printed on the printed matter is made the storage confirmation information is described. FIG. 14A is an example of a screen prompting the generation of the storage confirmation information displayed on the user terminal 20. On the screen, a message 1401 displaying a question regarding the object in the printed matter and a button icon 1402 for inputting an answer thereto are displayed. The user obtains the answer to the question with reference to the printed matter, taps the button icon 1402 to display a UI for inputting the answer, and inputs the answer as the storage confirmation information according to the UI. After inputting, the screen is switched to a transmission confirmation screen of the storage confirmation information an example of which is illustrated in FIG. 14B, and when a button icon 1411 for transmitting the storage confirmation information to the printed matter management device 10 is tapped, the generated storage confirmation information is transmitted to the printed matter management device 10. Note that the printed matter management device 10 may request an answer to a different question as the storage confirmation information each time the confirmation processing is performed.

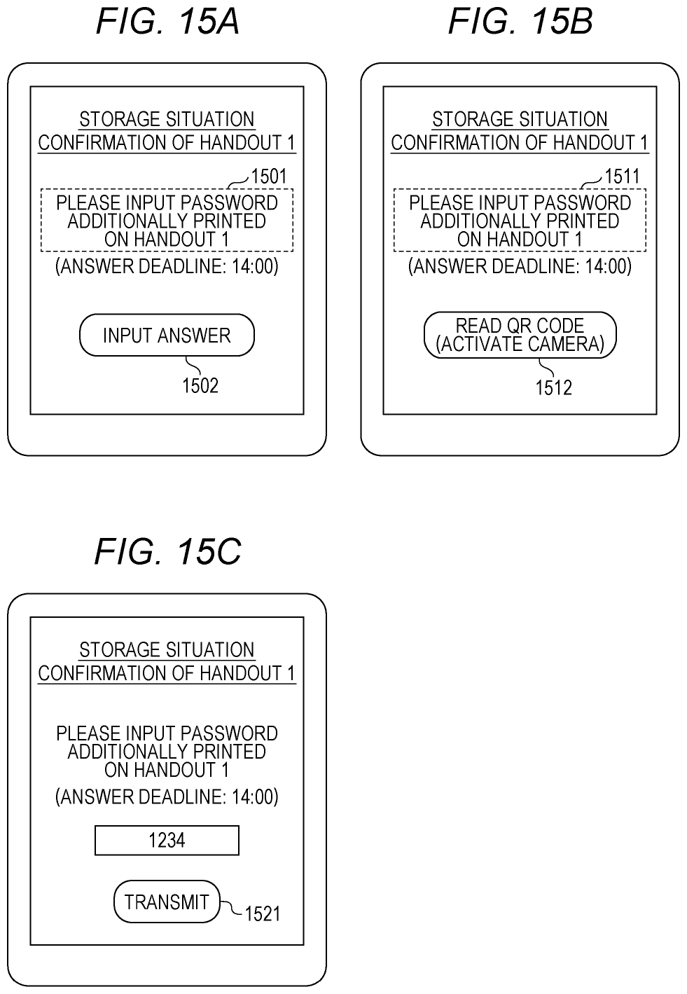

The generation of the storage confirmation information in a case where an additionally printed object (password) printed on the printed matter is made the storage confirmation information is described. FIGS. 15A and 15B are examples of a screen prompting the generation of the storage confirmation information displayed on the user terminal 20.

On the screen in FIG. 15A, a message 1501 of an instruction to input the password additionally printed in the printed matter and a button icon 1502 for inputting the password are displayed. The user obtains the password with reference to the printed matter, taps the button icon 1502 to display a UI for inputting the answer, and inputs the password as the storage confirmation information according to the UI. After inputting, the screen is switched to a transmission confirmation screen of the storage confirmation information an example of which is illustrated in FIG. 15C, and when a button icon 1521 for transmitting the storage confirmation information to the printed matter management device 10 is tapped, the generated storage confirmation information is transmitted to the printed matter management device 10.

On the screen in FIG. 15B, a message 1511 of an instruction to input the password additionally printed in the printed matter and a button icon 1512 for activating a two-dimensional code reader for obtaining the password are displayed. The user taps the button icon 1512 to activate the two-dimensional code reader, puts the two-dimensional code additionally printed on the printed matter within the imaging range, and reads the two-dimensional code, so that the password additionally printed on the printed matter is obtained as the storage confirmation information. After obtaining the password, the screen is switched to a transmission confirmation screen of the storage confirmation information an example of which is illustrated in FIG. 15C, and when a button icon 1521 for transmitting the storage confirmation information to the printed matter management device 10 is tapped, the generated storage confirmation information is transmitted to the printed matter management device 10.

Note that, in a case where a different password is additionally printed for each page of the printed matter, the printed matter management device 10 may request the password of the different page as the storage confirmation information each time the confirmation processing is performed.

1.5 Summary

According to the printed matter management system of this embodiment, since it is periodically confirmed whether the user appropriately stores the printed matter to be managed for each confirmation date and time, it is possible to grasp the loss at a timing earlier than a timing when the printed matter is returned. Since information that cannot be generated unless the printed matter is appropriately stored is made the storage confirmation information, it is difficult to camouflage the loss of the printed matter even though the printed matter is lost.

[2] Variation

Although the present disclosure is described above with reference to the embodiment, it goes without saying that the present disclosure is not limited to the above-described embodiment, and the following variation may also be implemented.

(1) In the above-described embodiment, the user terminal 20 and the printed matter management device 10 communicate with each other using the dedicated application installed in the user terminal 20, but the communication may be performed by another method. For example, it is possible to configure such that a mail in which a message requesting storage confirmation information is described in a body text is transmitted from the printed matter management device 10 to the user terminal 20, and the user terminal 20 transmits a mail to which the generated storage confirmation information is attached to the printed matter management device 10. It is also possible to configure such that a dedicated web site for uploading the storage confirmation information is prepared for each user, and the storage confirmation information is uploaded to the dedicated web site, so that the storage confirmation information is transmitted from the user terminal 20 to the printed matter management device 10.

(2) In the above-described embodiment, in a case where the captured image data is made the storage confirmation information, the printed matter management device 10 may request image data in which both a face of a person and the printed matter are captured. Then, the printed matter management device 10 may register face photograph data of a user as user information together with print image data included in print information 112 as printed matter-related information, thereby confirming that the person included in the storage confirmation information is the user who executes printing. Note that the captured image data may be still image data or moving image data.

(3) In the above-describe embodiment, although the print image data included in the print information 112 as the printed matter-related information is collated with the captured image data generated as the storage confirmation information, at that time, it may be confirmed that a data creation date is within a predetermined time before a confirmation time point with reference to meta data of the captured image data. By confirming data creation time, it becomes difficult for a user who has lost the printed matter to camouflage as if the printed matter is stored using the storage confirmation information created before the printed matter is lost.

(4) In the above-described embodiment, a case where users A and B print the same document to be managed is conceivable. In this case, a case where a password additionally printed on the printed matter is used as the storage confirmation information is further considered. At that time, a different password may be additionally printed for each user. As a result, for example, even if the user A who has lost the printed matter obtains the password from the user B who stores the printed matter, it is not possible to camouflage that the printed matter is stored.

(5) In the above-described embodiment, the configuration that the image formation device that generates the printed matter is the printed matter management device that executes management of the printed matter is described, but the printed matter management system of the present disclosure is not limited thereto.

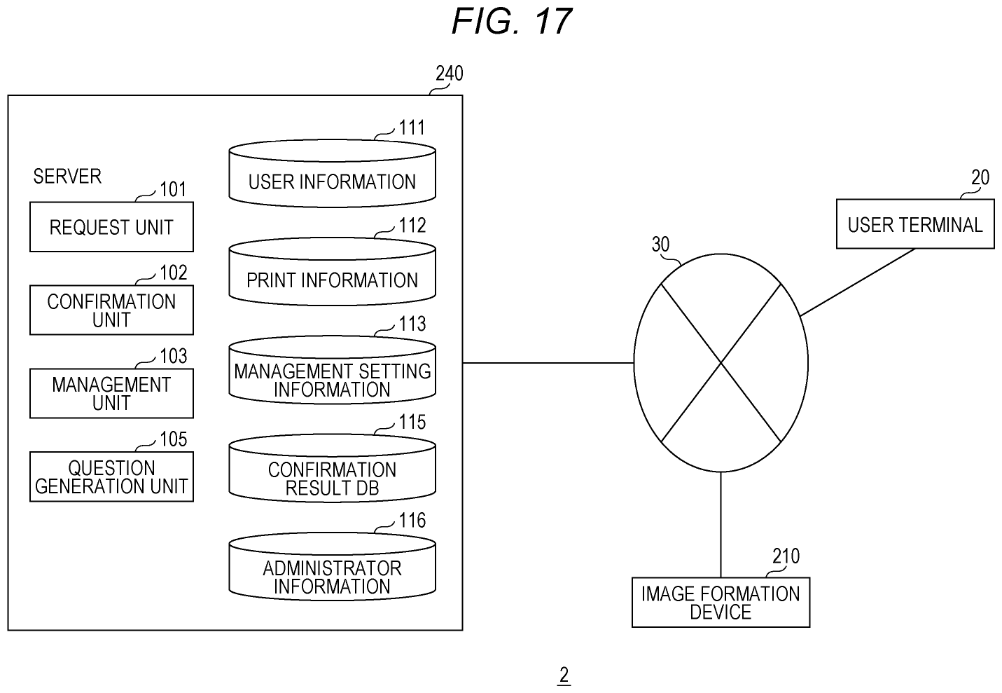

FIG. 17 is a view illustrating a configuration of a printed matter management system 2 in which a server device 240 different from an image formation device 210 serves as a printed matter management device that executes management of a printed matter.

The server device 240 is provided with the request unit 101, the confirmation unit 102, the management unit 103, and the question generation unit 105 provided on the printed matter management device 10 in the first embodiment, and stores user information 111, print information 112, management setting information 113, a confirmation result DB 115, and administrator information 116. The image formation device 210 has the same configuration as that of the printed matter management device 10 except that the request unit 101, the confirmation unit 102, the management unit 103, and the question generation unit 105 are not provided and the confirmation result DB 115 is not stored. Then, when the print information 112 generated by a print information generation unit 104 is transmitted to the server device 240, the server device 240 may execute the same confirmation processing as that of the printed matter management device 10.

(6) In the above-described embodiment, the print information 112 may further include an item of management deadline, and a certain management deadline or a management deadline according to a printed matter attribute information of a user who prints may be set when the print information 112 is generated. Then, the print information 112 the management deadline of which has passed may be discarded.

(7) In the above-described embodiment, user authentication may be performed before storage confirmation of the printed matter. The user authentication may be performed, for example, by the following procedure. The printed matter management device 10 stores in advance a user ID and a user password as user information. The user transmits user authentication information (the user ID and user password) to the printed matter management device 10 via the user terminal 20. The user authentication information received by the printed matter management device 10 is collated with the user ID and user password stored in advance. This user authentication may be executed, for example, between step S14 and step S15 in the above-described embodiment. By executing the user authentication, it is possible to authenticate whether a person who operates the user terminal 20 is a person registered in the printed matter management device 10 (a person who executes printing of a printed matter to be managed).

The present disclosure is applicable to a system that manages a confidential document.

Although embodiments of the present invention have been described and illustrated in detail, the disclosed embodiments are made for purposes of illustration and example only and not limitation. The scope of the present invention should be interpreted by terms of the appended claims.

What is claimed is:

1. A printed matter management device comprising:
a hardware processor that:
requests storage confirmation information for confirming whether a printed matter to be managed is stored from a user who has printed the printed matter;
determines whether the printed matter is stored based on the storage confirmation information; and
records a determination result.

2. The printed matter management device according to claim 1, comprising:
a storage that stores information related to a content of the printed matter, wherein
the hardware processor determines whether the printed matter is stored using the information related to the content of the printed matter.

3. The printed matter management device according to claim 2, wherein
the storage confirmation information is captured image data obtained by imaging the printed matter, and
the hardware processor confirms whether the printed matter is stored by collating print image data obtained from the information related to the content of the printed matter with the captured image data.

4. The printed matter management device according to claim 2, wherein
the printed matter is obtained by printing document data including one or more object data,
the information related to the content of the printed matter is an answer to a question related to a content of the object data,
the storage confirmation information is an answer by the user to the question, and
the hardware processor determines whether the printed matter is stored by confirming whether the answer received from the user coincides with the answer obtained from the information related to the content of the printed matter.

5. The printed matter management device according to claim 4, wherein
the object data is data showing either a text or an image

6. The printed matter management device according to claim 2, wherein
the information related to the content of the printed matter and the storage confirmation information are additional information additionally printed on the printed matter, and
the hardware processor determines whether the printed matter is stored by confirming whether the storage confirmation information coincides with the information related to the content of the printed matter.

7. The printed matter management device according to claim 6, wherein
the additional information is a password including a text of one or more characters additionally printed on the printed matter.

8. The printed matter management device according to claim 7, wherein
the password is encoded into a two-dimensional code and printed.

9. The printed matter management device according to claim 1, wherein
the printed matter to be managed is obtained by printing document data to which a specific attribute is assigned as document information.

10. The printed matter management device according to claim 1, wherein
the printed matter to be managed is a printed matter printed by a specific user.

11. The printed matter management device according to claim 2, wherein
a management deadline is set to the information related to the content of the printed matter, and
the information related to the content of the printed matter is discarded when the management deadline passes.

12. The printed matter management device according to claim 1, wherein
in a case where it is requested a plurality of times for the same printed matter, the hardware processor requests transmission of storage confirmation information of a different content from a previous content at the time of second and subsequent requests.

13. The printed matter management device according to claim 3, wherein
the hardware processor confirms that an elapsed time from a data creation date and time of the captured image data is within a predetermined time.

14. The printed matter management device according to claim 2, wherein
the storage further stores face image data of the user who has printed the printed matter,
the storage confirmation information is captured image data obtained by capturing the printed matter and a person in one image, and
the hardware processor determines whether the printed matter is stored by collating print image data obtained from the information related to the content of the printed matter with the captured image data and further collating the face image data with the captured image data.

15. The printed matter management device according to claim 2, wherein
the storage stores a predetermined contact address, and
in a case where the storage of the printed matter by the user cannot be confirmed, the hardware processor transmits a confirmation result to the contact address.

16. The printed matter management device according to claim 1, comprising:
a display, wherein
in a case where the storage of the printed matter by the user cannot be confirmed, the hardware processor displays a confirmation result on the display.

17. The printed matter management device according to claim 2, comprising:
an image former that generates the printed matter by forming an image on a sheet based on a print job; and
a generation part that generates the information related to the content of the printed matter based on the print job.

18. The printed matter management device according to claim 2,
that obtains the information related to the content of the printed matter from an image formation device that generates the printed matter by forming an image on a sheet based on a print job and generates the information related to the content of the printed matter based on the print job, and stores the information in the storage.

19. A printed matter management system comprising:
the printed matter management device and the image formation device according to claim 18.

20. A non-transitory recording medium storing a computer readable program installed in a mobile terminal and used for managing a printed matter, the program allowing the mobile terminal to execute:
receiving a request of storage confirmation information for confirming whether the printed matter is stored from a printed matter management device that manages the printed matter;
generating the storage confirmation information; and
transmitting the generated storage confirmation information to the printed matter management device.

21. The non-transitory recording medium storing a computer readable program according to claim 20, wherein
the request includes specification of an imaging part of the printed matter, and
the generating includes imaging the imaging part with a camera provided on the mobile terminal

22. The non-transitory recording medium storing a computer readable program according to claim 20, wherein
the request includes a question about a print content of the printed matter, and
the generating includes displaying the question on a display part provided on the mobile terminal, and receiving an input of an answer to the question by an inputter provided on the mobile terminal

23. The non-transitory recording medium storing a computer readable program according to claim 20, wherein
the generating includes reading a two-dimensional code printed on the printed matter with a two-dimensional code reader provided on the mobile terminal.
